(19) United States
(12) Patent Application Publication
(10) Pub. No.: US 2021/0090452 A1
(43) Pub. Date: Mar. 25, 2021

(54) Education System and Method

(71) Applicant: Ichthys Digital Initiatives, LLC, Ridgefield Park, NJ (US)

(72) Inventor: Lope Lesigues, Ridgefield Park, NJ (US)

(21) Appl. No.: 17/027,216

(22) Filed: Sep. 21, 2020

Related U.S. Application Data
(60) Provisional application No. 62/903,205, filed on Sep. 20, 2019.

(51) Int. Cl. G09B 5/12; G09B 5/14; H04L 12/58

(52) U.S. Cl. CPC G09B 5/12; H04L 51/10; G09B 5/14

(57) ABSTRACT

An education system and method. Tasks are created and customized in a leader's dashboard and sent to a student electronically, wherein the tasks are “I DID IT” tasks, photo tasks and audio tasks. The tasks are performed by the student. “I DID IT” tasks are automatically marked checked or “DONE,” and performed photo and audio tasks are sent electronically to the student's parent or guardian for review. Upon review, if the task is satisfactory, the parent or guardian validates the completed task for which the student receives an electronic badge and the student proceeds to a next level of tasks. If the task is not satisfactory, the task is sent back to the student electronically to be redone.

### CROSS-REFERENCE TO RELATED APPLICATION

This application claims priority to U.S. Provisional Application No. 62/903,205 entitled “Education System and Method,” filed on Sep. 20, 2019, which is incorporated by reference in its entirety.

### FIELD

The present disclosure relates to education and in particular to an education system and method.

### BACKGROUND

Methods of education have been in an upheaval due to rapid developments in technology. Technological advances such as the Internet and YOUTUBE, and education channels such as KHAN ACADEMY have facilitated widespread changes in the approaches to education within and beyond the classroom. For example, in using KHAN ACADEMY, students are encouraged to learn through the use of gamification mechanisms, such as the awarding of badges and points for viewing educational videos as well as successful completion of exercises.

One area of education which has been slow in adopting technology has been religious education. Mired in the traditional classroom approach, religious education typically involves rote learning, memorization, and book-based storytelling, with some educational activities outside the confines of the classroom, such as reading assignments at home, self-study, and some making of religious crafts. The assignment methodologies in the prior art, especially in connection with religious education, have failed to utilize game triggers as effective tools in engaging students. In particular, there is no conscious use of game triggers in religious education in the prior art. Whatever few game triggers that the old school educational mentality has adopted do not translate to executable or livable action plans. The assignments and take-home activities are not meant to create active participants in religious education, but are meant to perpetuate children as passive recipients of their formation.

Another problem with current learning methods is accessibility. That is, students, especially younger students without means for transportation, may not be able to attend classes or lessons in person for various reasons. For example, a child may not be able to attend an extracurricular education class because of conflicting schedules of the child and/or the parent.

A need exists for the adoption of technology and game triggers in education systems and methods, especially in connection with religious education.

A need also exists for an effective means for providing remote educational lessons for the young.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention provides an education system for performing a method comprising the following steps: (i) tasks are created and customized in a leader's dashboard; (ii) a student finds the tasks in the student's gadget, wherein the tasks are under at least three categories comprising “I DID IT” tasks, photo tasks and audio tasks; (iii) the tasks are performed by the student; (iv) performed “I DID IT” tasks are automatically marked checked or “DONE” in the student's gadget, performed photo tasks are sent electronically to the student's parent or guardian for review, and performed audio tasks are sent electronically to the student's parent or guardian for review, wherein the tasks with photos and audio recordings are sent to the student's parent or guardian as they appear in the student's gadget; (v) the parent or guardian views the photo or listens to the audio recordings submitted by the student on a parent or guardian gadget; (vi) if the task is satisfactory, the parent or guardian actuates a “VALIDATE” button on and validates the completed task; (vii) if the task is not satisfactory, the parent or guardian actuates a “REDO” button and the task is sent back to the student to be redone; and (viii) if the task is validated, the student receives an electronic badge and the student proceeds to a next level of tasks.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 illustrates an education process of the present invention;

FIG. 2 illustrates task creation using a default method;

FIG. 3 illustrates task creation using a drag-and-drop method;

FIG. 4 illustrates task completion for I DID IT tasks;

FIG. 5 illustrates task completion using a photo;

FIG. 6 illustrates task completion using audio;

FIG. 7 illustrates parental validation of photo-completed tasks;

FIG. 8 illustrates parental validation of audio-completed tasks;

FIG. 9 illustrates child completion of tasks;

FIG. 10 illustrates administrator creation and management of tasks;

FIG. 11 illustrates game triggers; and

FIG. 12 illustrates a system for implementing the present invention.

To facilitate an understanding of the invention, identical reference numerals have been used, when appropriate, to designate the same or similar elements that are common to the figures. Further, unless stated otherwise, the features shown in the figures are not drawn to scale and are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left may be used to describe the accompanying figures. The terminology includes the words above specifically mentioned, derivatives thereof, and words of similar import.

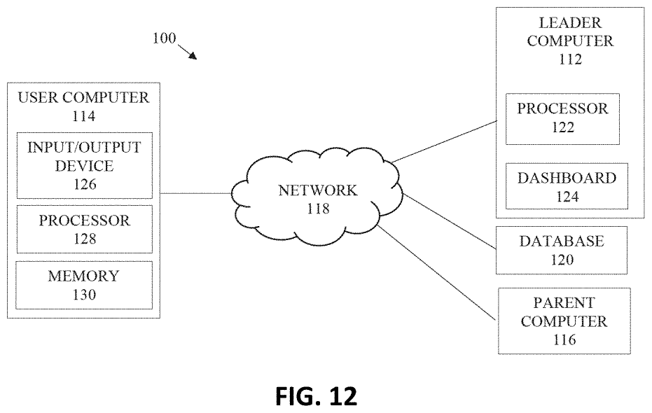

As shown in FIG. 12, an education system 100 for implementing the present invention provides an educational environment for children and/or students. In a religious context, the educational environment may be called God's Park (GP). The education system 100 includes a leader computer 112, a user computer 114, and a parent computer 116, which communicate with each other through a network 118, such as the Internet, or other known communication systems using known protocols, such as a local area network (LAN), a wide area network (WAN), or combinations thereof. The various computers 112, 114, 116 may also interact with a database 120 through the network 118.

The leader computer or gadget 112 includes a processor 122, and an input/output device for displaying a graphical user interface (GUI) presenting a dashboard 124 to a leader, who may be an administrator of the education system 100. The user computer or gadget 114 includes an input and/or output device 126, a processor 128, and a memory 130 for use by a student, such as a child. The user computer 114 may be a gadget such as a smartphone, a tablet, or other types of computing devices. The parent computer or gadget 116 also includes an input and/or output device, a processor, and a memory for use by a parent of the student or child. Each of the leader computer 112, the user computer 114, and the parent computer 116 may be any known computing device, such as a personal computer having 2 GB of RAM, a 30-40 GB hard disk, and a 15 inch screen display, with the computing device capable of operating an Internet browser such as GOOGLE CHROME, MICROSOFT EDGE, INTERNET EXPLORER, SAFARI, and MOZILLA FIREFOX. With such a computing configuration using personal computers, the system 100 may operate with high-resolution graphics. Alternatively, each of the leader computer 112, the user computer 114, and the parent computer 116 may be any known computing device in the form of a smartphone or other known type of gadget operating using iOS or ANDROID as operating systems. Accordingly, such gadgets may operate with low-resolution graphics.

The system 100 and method of operation of the present invention may be embodied as a software application operating on at least the leader computer 112 in conjunction with the user computer 114, with the software application written, for example, in the C# programming language and developed on the MICROSOFT WINDOWS development platform, or alternatively, the UNITY 3D development platform. Other known programming languages may be used, for example, to implement the leader dashboard 124, such as PHP, JQUERY, JAVASCRIPT, HTMLS, JSON, SQL, CSS, LESS, etc. The software application is compiled to operate on any known platform and/or operating system including WINDOWS, macOS, HTML 5, LINUX, iPhone, iOS, and ANDROID phones, for example, embodied as a smartphone functioning as the user computer 114. In addition, the software application may include instructions executed by a processor, such as the processor 122, the processor 128, and/or a processor operating the parent computer 116, with the software application possibly embodied on a non-transitory computer medium, such as the memory 130 or other known storage media.

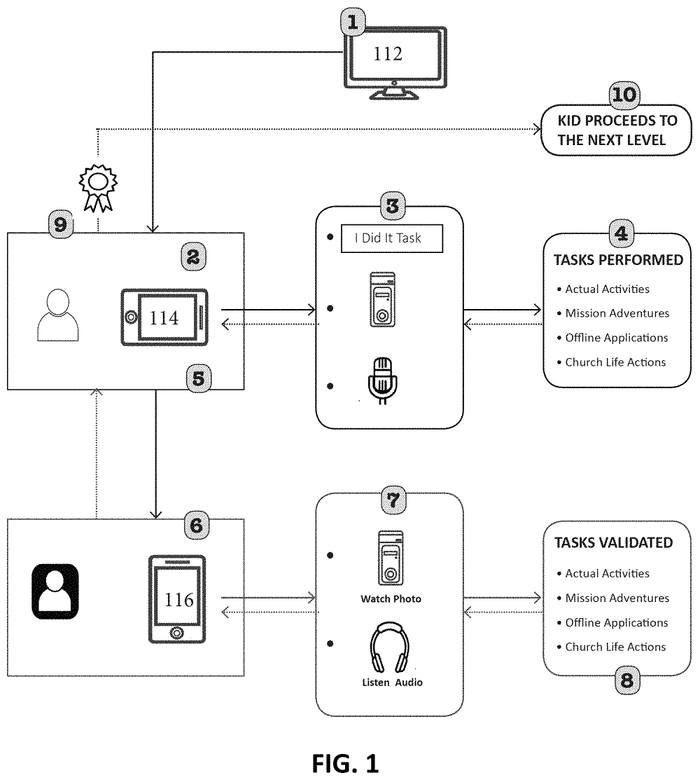

FIG. 1 illustrates an education process of the present invention, which begins in step 1 with tasks being created and customized by a leader or administrator using the dashboard 124. Then, in step 2, the child finds the tasks through the input/output device 126, such as a GUI on a display which displays the tasks. A task may be any type of media, such as a text assignment, a photo, a video, an audio clip or recording, a multimedia element, etc. The tasks may include actual activities, mission adventures, offline applications, and church life actions. The tasks are grouped in step 3 under one of three categories: “I DID IT” tasks, photo tasks, and audio tasks. For example, the child may receive a text assignment instructing the child to go view a religious statue. The tasks are performed by the child in step 4. In step 5, the tasks performed by the child are processed. Performed “I DID IT” tasks are automatically marked as checked or DONE in the gadget associated with the child, such as in the memory 130 of the user computer 114. Alternatively, an account or list of tasks associated with the child and stored in the database 120 is updated to reflect the checking off or indicating of the task being DONE. On the contrary, performed photo and audio tasks need to be validated in steps 6 to 8 by a parent or guardian of the child. For example, a photo task may be for a child to take a selfie with the family in front of an altar before or after religious services such as Mass.

In step 6, tasks with photos and audio recordings are sent to the parents or guardians, as the performed tasks appear in the gadgets associated with the parents/guardians, such as the parent computer 116. The parent/guardian is able to view/watch the photos and/or listen to the audio recordings submitted by the child in step 7. In a preferred embodiment, no photo or audio recording is ever saved, since, as soon as the media are viewed by the parent, the media are automatically erased. The parent can either reject or validate the task in question from the child. In step 8, if the parent determines that the performed task is satisfactory, the parent hits, clicks, or otherwise actuates a VALIDATE button or icon in a GUI of the parent computer 116. Such validation causes the task to be marked as checked, for example, in a memory of the parent computer 116. Alternatively, an account or list of tasks associated with the child and stored in the database 120 is updated to reflect the checking off or indicating of the task being VALIDATED. The validation by a parent or guardian of photo or audio tasks completed by a child creates and/or encourages conversation within the family and within the community, as well as promoting better interaction and/or teamwork between parents and children, for example, in the area of faith formation. In addition, photo and audio tasks are more hands-on, practical, and actionable for both the child and the validating parent.

However, if the parent does not consider the performed task to be satisfactory, the parent hits, clicks, or otherwise actuates a REDO button or icon in the GUI of the parent computer 116. The unfinished or non-validated task is sent back to the child to be redone. Hopefully, with the opportunity to redo the task and/or with guidance from the parent, teachers, or other authority figures, the child successfully re-performs a task which is validated by a parent in step 9. In this circumstance, a button or icon, corresponding to a validated state, is displayed to the child, such as through a GUI of the input/output device 126 of the user computer 114. The child then hits, clicks, or otherwise actuates the button or icon, which unlocks Holy Collectible and Sacred Badges, such as a ribbon icon. In step 10, the child is now ready to proceed to a next level, such as a new set of tasks for the child from the leader using the leader computer 112.

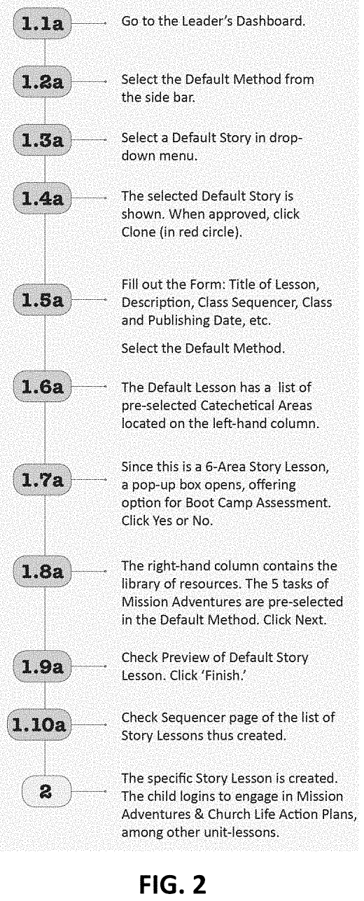

FIG. 2 illustrates task creation using a default method, which illustrates step 1 in FIG. 1 in greater detail. The leader goes to the dashboard 124 in step 1.1a, and the leader then selects a default method on the dashboard 124 in step 1.2a, such as by using a side bar in a GUI of the leader computer 112. The leader then selects a default story in step 1.3a using a drop-down menu displaying at least one story. The selected default story is then shown to the leader using the dashboard 124 in step 1.4a. If the leader approves the use of the default story, the leader clicks an icon such as a CLONE icon in a red circle, which copies the default story for use by the leader with a child. The leader then fills out a form in step 1.5a, which has a title of a lesson, a description, a class sequencer, a class and publishing date, etc., and the leader selects the default method.

In step 1.6a, the default lesson has a list of pre-selected areas, such as catechetical areas or topics, located on the dashboard 124, such as in a left-hand column. The default lesson may be a six-area story lesson. In step 1.7a, because the default lesson is a six-story lesson, a pop-up box or window opens on the dashboard 124, which gives the leader the option for performing a boot camp assessment of the child. The leader then selects or clicks YES or NO to initiate or to not initiate a boot camp assessment. In step 1.8a, the dashboard 124 displays to the leader a library of resources, such as in a right-hand column. There may be five tasks of mission adventures which are pre-selected in the default method. The leader then clicks a NEXT button or icon. In step 1.9a, the leader checks a preview of the default story lesson, and then clicks a FINISH button or icon. In step 1.10a, the leader then checks a sequencer page including a list of story lessons automatically created by default, and the default method proceeds to step 2 in Diagram 1 with a specific story lesson created. The child then logs into the system 100 using the user computer 114 in order to engage in mission adventures and church life action plans, among other unit-lessons.

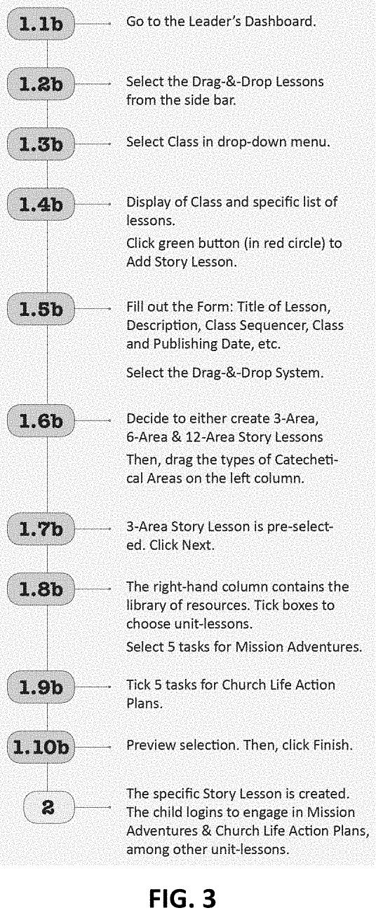

Alternatively, instead of a default method of task creation, the leader may customize the task creation. FIG. 3 illustrates task creation using a drag-and-drop method. In step 1.1b, the leader goes to the dashboard 124, and in step 1.2b, the leader selects drag-and-drop lessons, for example, from a side bar displayed on the dashboard 124. In step 1.3b, the leader selects a class using a drop-down menu in the dashboard 124, and in step 1.4b, the dashboard 124 displays the selected class and a specific list of lessons associated with the class. The leader then clicks a green button in a red circle to add a story lesson to the class in step 1.5b. In step 1.6b, the leader decides whether to create a three-area story lesson, a six-area story lesson, or a twelve-area story lesson, and the leader drags the types of catechetical areas to a predetermined portion of the dashboard 124, such as a left column. For example, as shown in FIG. 3, step 1.7b, a three-area story lesson is pre-selected, and the leader clicks a NEXT button or icon.

In step 1.8b, a portion of the dashboard 124 lists a library of resources, such as in a right-hand column. The leader then ticks or selects boxes to choose unit-lessons, and in step 1.9b, the leader selects five tasks for mission adventures. The leader then previews the selections in step 1.10b, and clicks a FINISH button or icon. The drag-and-drop method then proceeds to step 2 in FIG. 1 with a specific story lesson created. The child then logs into the system 100 using the user computer 114 in order to engage in mission adventures and church life action plans, among other unit-lessons.

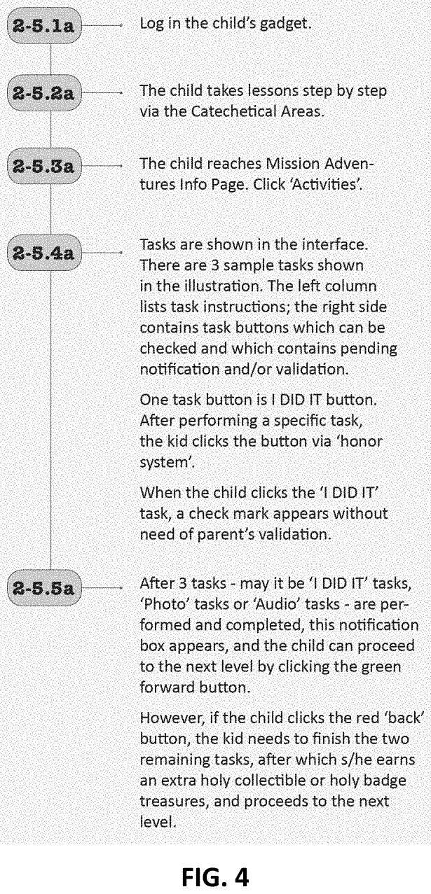

FIG. 4 illustrates task completion for I DID IT tasks, in which steps 2 to 5 in FIG. 1 are described in greater detail for I DID IT tasks. In steps 2-5.1a, the child logs into the system 100 using the gadget associated with the child. In steps 2-5.2a, the child then takes lessons step by step via the catechetical areas. In steps 2-5.3a, the child reaches a mission adventures information page, and clicks or otherwise actuates an ACTIVITIES button, icon, or hyperlink. In steps 2-5.4a, tasks are shown to the child in the GUI of the input/output device 126, for example, with three tasks. Task instructions are listed and displayed in a left column of the GUI, and task buttons are displayed on the right side of the GUI, with the task buttons capable of being checked, and which contain any pending notifications and/or validations of tasks. One task button is labeled I DID IT, which the child clicks after performing a specific task. In a preferred embodiment, the child is trusted via the honor system to only click the I DID IT button after completion of the task, because when the child clicks the I DID IT button, a check mark appears next to the task and a notation of the completed I DID IT task is stored in the memory 130 and/or in the database 120 without the need of validation by a parent. In steps 2-5.5a, after three tasks are performed and completed, including I DID IT tasks, photo tasks, and audio tasks, a notification box is displayed on the GUI of the user computer 114, and the child can proceed to a next level by clicking a green FORWARD button. However, if the child clicks the red BACK button, the child needs to finish two remaining tasks, after which the child earns an extra holy collectible or holy badge treasure, and the child then proceeds to a next level.

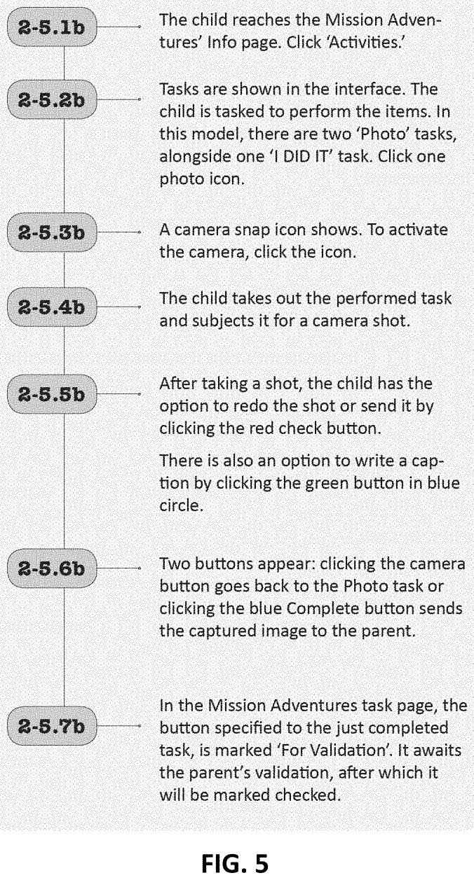

FIG. 5 illustrates task completion using a photo, in which steps 2 to 5 in FIG. 1 are described in greater detail for photo tasks. In steps 2-5.1b, the child reaches a mission adventures information page, and clicks or otherwise actuates an ACTIVITIES button, icon, or hyperlink. In steps 2-5.2b, tasks are shown in a GUI of the user computer 114. For example, there may be icons for two photo tasks and one I DID IT task, and the child clicks on one of the photo task icons. In steps 2-5.3b, a camera snap icon is displayed. To activate the camera, the child clicks the camera snap icon. In steps 2-5.4b, the child takes out the performed task and subjects the object of the task to be photographed; that is, to capture an image of the object. After taking the photograph of the object, in steps 2-5.5b, the child has the option to redo the photo or to send the photo to a parent by clicking a red check button. In addition, there is also an option to write a caption of a taken photo by clicking a green button in a blue circle. In steps 2-5.6b, two buttons are displayed in the GUI: a camera button and COMPLETE button, which may be colored blue. Clicking the camera button returns the child to the photo task to be performed. However, clicking the COMPLETE button, sends the photo to the parent. In steps 2-5.7b, in a mission adventures task page displayed on the GUI, a button is specified for a just completed task, and so the button is marked or labeled FOR VALIDATION, after which the corresponding task awaits validation by a parent. Upon validation by a parent, the completed task is marked as checked.

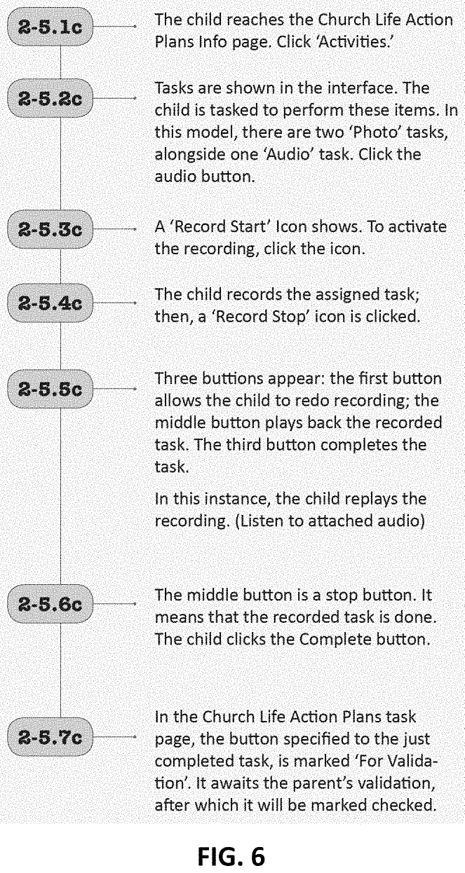

FIG. 6 illustrates task completion using audio, in which steps 2 to 5 in FIG. 1 are described in greater detail for audio tasks. In steps 2-5.1c, the child reaches a church life action plans information page, and clicks or otherwise actuates an ACTIVITIES button, icon, or hyperlink. In steps 2-5.2c, tasks are shown in a GUI of the user computer 114, and the child is tasked to perform the items or actions of such tasks. For example, there may be icons for two photo tasks and one audio task, and the child clicks the audio task button. In steps 2-5.3c, a RECORD START icon is shown, and activation of the icon activates recording of audio. In steps 2-5.4c, the child records an assigned task, and then a RECORD STOP icon is clicked to stop the recording. In steps 2-5.5c, three buttons or icons appear in the GUI. Actuation of a first button allows the child to redo a recording, actuation of a second button plays back a recorded task, and a third button completes the audio task. In steps 2-5.6c, a stop button is displayed in the GUI, which is actuated by a child when the recorded task is done, and then a COMPLETE button is actuated by the child. In steps 2-5.7c, a church life action plans task page is displayed in the GUI, and a button is specified for a just completed task, and so the button is marked or labeled FOR VALIDATION, after which the corresponding task awaits validation by a parent. Upon validation by a parent, the completed task is marked as checked.

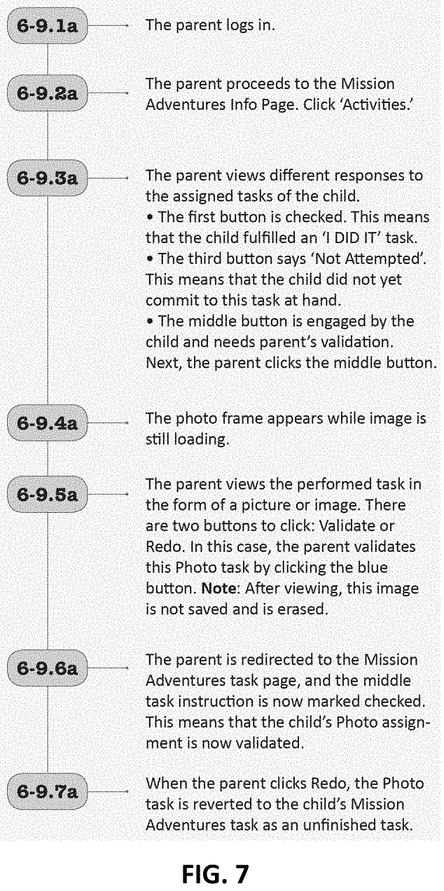

FIG. 7 illustrates parental validation of photo-completed tasks in which steps 6 to 9 in FIG. 1 are described in greater detail for photo tasks. In steps 6-9.1a, a parent logs into the system 100 through the parent computer 116, and the parent proceeds in steps 6-9.2a to a mission adventures information page displayed in a GUI of the parent computer 116. An ACTIVITIES button is displayed, which the parent clicks. In steps 6-9.3a, a parent views different responses to tasks assigned to a child. For example, if a button is checked, then the child fulfilled an I DID IT task. If a button has the notation NOT ATTEMPTED, then the child did not yet commit to performing the corresponding task. However, if a child engages in a photo or audio task, a button in the GUI of the parent computer 116 indicates that a task was engaged by a child and needs parental validation, and so the parent clicks on the corresponding button. In steps 6-9.4a, a photo frame or template is displayed in the GUI as a photo is being loaded. In steps 6-9.5a, the parent views the performed task in the form of a photo, picture, or image, and the parent is presented with two buttons in the GUI: a VALIDATE button and a REDO button. If the parent clicks on the VALIDATE button, the completed task of the child is validated. However, if the parent clicks on the REDO button, the child must redo the task. In steps 6-9.6a, the parent is redirected to a mission adventures task page displayed in the GUI of the parent computer 116, and the validated task is now marked as checked, which indicates that a photo task or assignment performed by a child is now validated. In steps 6-9.7a, the parent has clicked on the REDO button, and the photo task is reverted to be a mission adventures task of the child as an unfinished task.

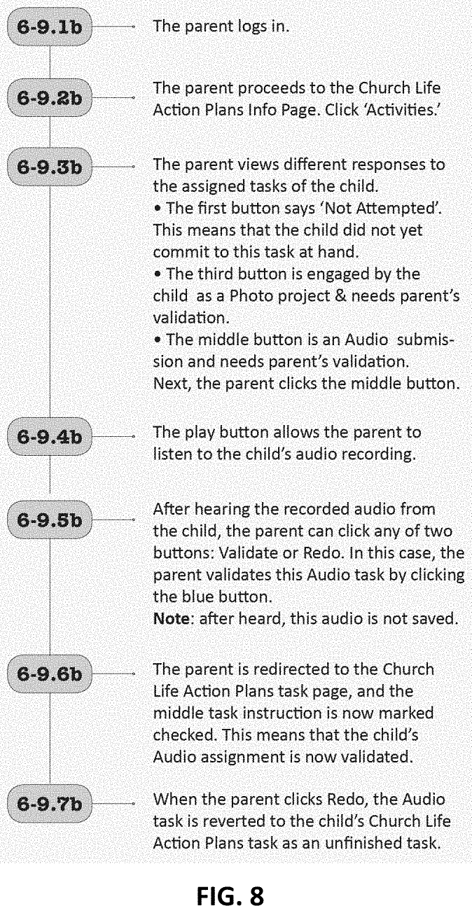

FIG. 8 illustrates parental validation of audio-completed tasks in which steps 6 to 9 in FIG. 1 are described in greater detail for audio tasks. In steps 6-9.1b, a parent logs into the system 100 through the parent computer 116, and the parent proceeds in steps 6-9.2b to a church life action plans information page displayed in a GUI of the parent computer 116. An ACTIVITIES button is displayed, which the parent clicks. In steps 6-9.3b, a parent views different responses to tasks assigned to a child. For example, if a button is checked, then the child fulfilled an I DID IT task. If a button has the notation NOT ATTEMPTED, then the child did not yet commit to performing the corresponding task. However, if a child engages in a photo or audio task, a button in the GUI of the parent computer 116 indicates that a task was engaged by a child and needs parental validation, and so the parent clicks on the corresponding button. In steps 6-9.4b, a PLAY button is displayed in the GUI, which allows a parent to listen to an audio recording of a child. In steps 6-9.5b, the parent hears the performed task in the form of an audio recording, and the parent is presented with two buttons in the GUI: a VALIDATE button and a REDO button. If the parent clicks on the VALIDATE button, the completed task of the child is validated. However, if the parent clicks on the REDO button, the child must redo the task. In steps 6-9.6b, the parent is redirected to a church life action plans task page displayed in the GUI of the parent computer 116, and the validated task is now marked as checked, which indicates that an audio task or assignment performed by a child is now validated. In steps 6-9.7b, the parent has clicked on the REDO button, and the audio task is reverted to be a church life action plan task of the child as an unfinished task.

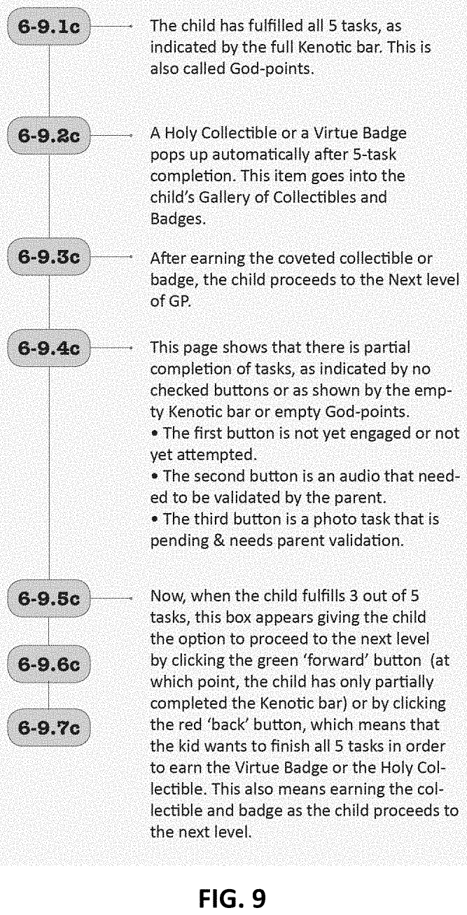

FIG. 9 illustrates child completion of tasks in which steps 6 to 9 in FIG. 1 are described in greater detail for completion of tasks. In steps 6-9.1c, a child has fulfilled all tasks presented to the child, such as a set of five tasks, as indicated by a status bar and/or a set of points displayed in a GUI by the input/output device 126. For example, the status bar may be called a kenotic bar in a religious context, which is full upon fulfillment of all tasks by a child. Alternatively, or in addition, a set of points called God-points in a religious context may also be indicated in the GUI. In steps 6-9.2c, a collectible or badge, which in a religious context may be called a holy collectible or a sacred or virtue badge, respectively, is displayed by popping up automatically in the GUI after the five tasks are completed. Such a collectible or a badge is then placed in a gallery of collectibles and badges in the GUI of the user computer 114 associated with the child. Such awarded collectibles and badges may also be stored and tracked in an account or list in the memory 130 and/or in the database 120. In steps 6-9.3c, after earning a coveted collectible or badge, the child proceeds to a next level of the educational environment. In steps 6-9.4c, a page displayed in the GUI of the user computer 114 indicates that there is a partial completion of tasks, as indicated by no checked buttons or icons, or otherwise indicated by an empty or partially full but not completely full kenotic bar or God-points. A first button is not yet engaged, indicating that a task is not yet attempted. A second button may indicate an audio task that is pending and needs to be validated by a parent. A third button may indicate a photo task that is pending and needs to be validated by a parent. In steps 6-9.5c to 6-9.7c, when a child fulfills three out of five tasks, a box or window appears in the GUI of the user computer 114 associated with the child, with the box or window indicating that the child has the option to proceed to a next level by clicking on a green FORWARD button, even though the child may have only a partially completed kenotic bar. Another option presented to the child is a red BACK button, such that a child who clicks on the BACK button wants to finish all five tasks to earn a virtue or sacred badge or a holy collectible. In addition, the child can earn such a collectible and/or badge as the child proceeds to a next level.

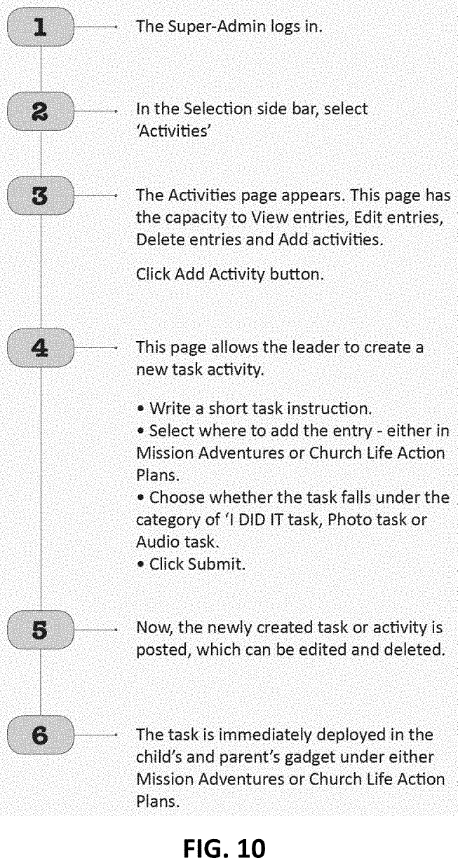

FIG. 10 illustrates administrator creation and management of tasks. A leader may be an administrator or super-administrator of the system 100. In step 1, a leader/administrator/super-administrator may log into the system 100, for example, using the leader computer 112. Then in step 2, the leader selects an ACTIVITIES button or icon, which may be displayed in a selection side bar of the dashboard 124. In step 3, an activities page is then displayed on the dashboard 124, which gives the leader the capacity or functionality to view entries, edit entries, delete entries, and add activities such as tasks to be conducted by a child and/or a student. Accordingly, an ADD ACTIVITY button or icon is displayed on the dashboard 124, and so a leader clicks on the ADD ACTIVITY button to add tasks and activities for a child and/or a student to complete. In step 4, a new page or window is displayed in or overlapping the dashboard 124, which allows a leader to create a new task activity, such as writing a short task instruction; selecting where to add an entry, such as in a list of mission adventures or a list of church life action plans; and choosing whether the task falls under one of the three categories of I DID IT tasks, photo tasks, and audio tasks. After filling the page or window with created information, the leader clicks a SUBMIT button or icon to submit the created task or activity to a list of tasks for the child or student. Such a list of tasks may be maintained in the memory 130 of the user computer 114 associated with the child, and/or may be maintained in the database 120 in an account or file associated with the child. In step 5, the newly created task or activity is posted for final editing, by which the leader can edit or even delete a newly created task or activity. In step 6, after final editing by the leader, the task is immediately deployed in both the gadgets of the child and the associated parent; that is, in the user computer 114 and the parent computer 116 associated with the child and the parent, respectively. Such deployed tasks are listed in the gadgets under either mission adventures or church life action plans.

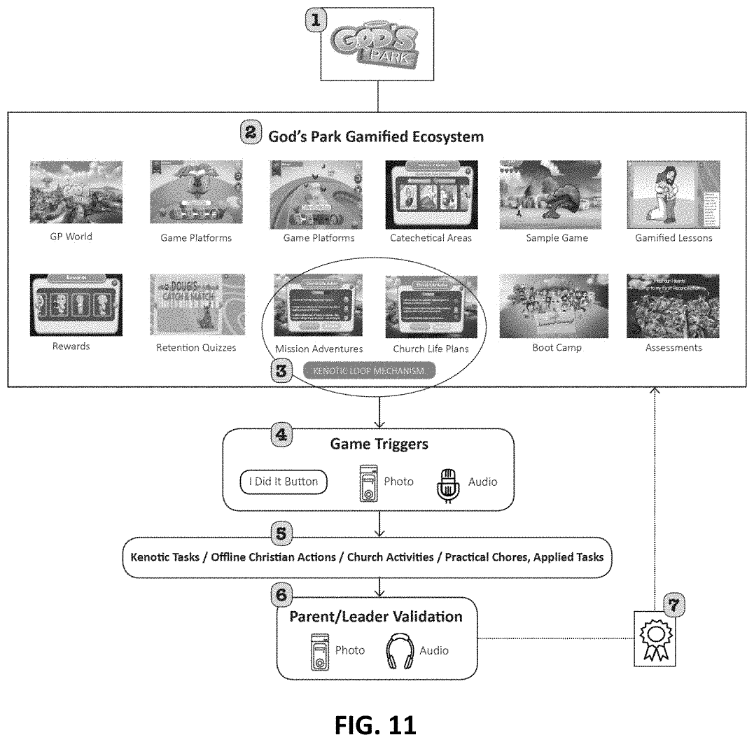

FIG. 11 illustrates game triggers. As shown in step 1 of FIG. 11, the educational environment of the present invention, using the educational system 100 described above, employs a kenotic loop mechanism, which is a set of game triggers that translates plans into actions, and tasks into activities. The educational environment, which may be called God's Park (GP) in religious contexts, also allows for joint participation and social engagement among users, such as children, parents, guardians, students, teachers, leaders, administrators, etc. In step 2, a child/user logs into the application, app, or applet operating on the gadget associated with the child. In logging in, the child enters into a gamified ecosystem of the educational environment of God's Park. All facets of the educational environment, such as videos, interactive texts, games, retention quizzes, assessments, mission tasks, rewards, and badges, leverage game mechanics and game dynamics to encourage learning in the child. For example, the educational environment may offer a virtual world which could be explored, a set of game platforms, catechetical areas, sample games, gamified lessons, rewards, retention quizzes, mission adventures, church life plans, a boot camp of mental exercises, assessments, etc.

In step 3, the child/user sees mission adventures and church life action plans as examples of the gamified kenotic loop mechanism. As with the other game facets of the educational environment of the present invention, tasks in mission adventures and church life action plans have missions to fulfill, such as photos to be taken, audio to record, hurdles to overcome, and buttons to unlock or to be displayed in order for the child/user to advance to a next level. In step 4, game triggers offer advantages in encouraging specific behavior of children, in pushing actionable moves by children, and in generating measurable feedback to the children, the parents, and the leaders. Such game triggers allow a leader to embed visible progression markers and engagement tools.

In step 5, with the unlocking of a next level in mind, the child/user enacts the assigned tasks, and the real work becomes an actual space for concrete solutions, participation, operations, live responses, and engagement. Tasks are accessible to children of different abilities and having challenging curiosities. In step 6, the parental and/or leader validation is enacted by an affirmation button or icon, the activation of which highlights joint engagement, accelerated motivation, and interactions with the child that are not found in the confines of book-oriented, classroom-limited approaches in the prior art. In step 7, after validation of a task or multiple tasks completed by a given child/user, such a section of tasks or multiple tasks is completed, and another portion of the educational environment is unlocked, allowing the child to advance to a next level, for example, in the gamified world.

In another aspect, the present invention provides a means for bulk-enrollment of students. In one embodiment, a “STUDENT” button is provided on a side menu bar on the leader's dashboard which the leader selects. Then an “IMPORT STUDENT” button appears and the leader clicks on the same. Then the leader is prompted to select a list of enrollees saved as an electronic file such as Excel. The leader selects the electronic file upon which a new screen is displayed for the leader to assign each student to a desired class. Each student is then linked to his respective class and the student list is imported.

In yet another aspect of the present invention, a means for managing assignments is provided. In the leader's taskbar, under an “ASSIGNMENTS” menu bar, the leader is provided with a “VIEW” button, an “ASSIGNED CLASS” button and a “MARKS” button associated with each assignment. When the “VIEW” button is clicked, an “ASSIGN” button is provided, which gives the leader options to set deadlines and to choose a specific class for assignment. Upon completion, the leader is prompted with an “ADD ASSIGNMENT” and a “START SENDING EMAILS” buttons for which the leader can choose to perform either function. Under the “MARKS” button, the leader is provided with options to either resend an email or record grades for a submitted assignment.

The present invention may be embodied in other specific forms without departing from its spirit or essential characteristics. The described embodiments are to be considered in all respects only as illustrative and not restrictive. For example, the education system and method described herein could be used for educational lessons in many different fields. Examples include, but are not limited to, music, math, reading comprehension, history, and other subject matters. The scope of the invention, therefore, will be indicated by claims rather than by the foregoing description. All changes, which come within the meaning and range of equivalency of the claims, are to be embraced within their scope.

1. An education system for performing a method comprising the following steps:
(i) tasks are created and customized in a leader's dashboard;
(ii) a student finds the tasks in the student's gadget, wherein the tasks are under at least three categories comprising “I DID IT” tasks, photo tasks and audio tasks;
(iii) the tasks are performed by the student;
(iv) performed “I DID IT” tasks are automatically marked checked or “DONE” in the student's gadget, performed photo tasks are sent electronically to the student's parent or guardian for review, and performed audio tasks are sent electronically to the student's parent or guardian for review, wherein the tasks with photos and audio recordings are sent to the student's parent or guardian as they appear in the student's gadget;
(v) the parent or guardian views the photo or listens to the audio recordings submitted by the student on a parent or guardian gadget;
(vi) if the task is satisfactory, the parent or guardian actuates a “VALIDATE” button on and validates the completed task;
(vii) if the task is not satisfactory, the parent or guardian actuates a “REDO” button and the task is sent back to the student to be redone; and
(viii) if the task is validated, the student receives an electronic badge and the student proceeds to a next level of tasks.
